(19) United States
(12) Patent Application Publication
(10) Pub. No.: US 2025/0330506 A1
(43) Pub. Date: Oct. 23, 2025

(54) LIVE INTERACTION ESTABLISHMENT METHOD AND APPARATUS, AND DEVICE, STORAGE MEDIUM AND PROGRAM PRODUCT

(71) Applicant: DOUYIN VISION (BEIJING) CO., LTD., Shijingshan District, Beijing (CN)

(72) Inventors: Yixu WANG, Beijing (CN); Xiaozhou CAO, Beijing (CN)

(21) Appl. No.: 18/864,173

(22) PCT Filed: Jun. 13, 2023
(86) PCT No.: PCT/CN2023/099934

§ 371 Date: Nov. 8, 2024

(30) Foreign Application Priority Data
Jun. 16, 2022 (CN) 202210686955.1

(51) Int. Cl. H04L 65/61; H04L 65/1069

(52) U.S. Cl. CPC H04L 65/61; H04L 65/1069

(57) ABSTRACT

The present disclosure relates to a live interaction establishment method and apparatus, and a device, a storage medium and a program product. The method includes: sending request information to a first server; receiving response information from the first server as feedback to the request information; and initiating a first connection of real time communication (RTC) to a second server based on the response information, before receiving allow information from the host terminal as feedback to the request information.

### CROSS-REFERENCE TO RELATED APPLICATIONS

The present disclosure is based on and claims priority of Chinese application for disclosure No. 202210686955.1, filed on Jun. 16, 2022, the disclosure of which is hereby incorporated into this disclosure by reference in its entirety.

### TECHNICAL FIELD

The present disclosure relates to the technical field of livestreaming, in particular to a live interaction establishment method and apparatus, a device, a storage medium and a program product.

### BACKGROUND

At present, with the development of the livestreaming industry, the needs of viewers are increasing. In order to attract viewers, hosts (streamers) can contact (live interaction) with viewers in their livestreams and achieve good interaction with viewers through live interaction actions.

During the live interaction process performed between a host and a viewer, after the viewer terminal receives allow information sent from the host terminal, the viewer terminal and the host terminal exchange media streams at a Real Time Communication (RTC) server via an RTC connection to the RTC server to display a live interaction screen and complete the live interaction establishment process.

### SUMMARY

According to a first aspect of some embodiments of the present disclosure, there is provided a live interaction establishment method applicable to a viewer terminal, comprising: sending request information to a first server, wherein the request information indicates a request for a live interaction with a host terminal; receiving response information from the first server as feedback to the request information; initiating a first connection of real time communication (RTC) to a second server based on the response information, before receiving allow information from the host terminal as feedback to the request information, wherein the allow information indicates that the host terminal agrees on live interaction with the viewer terminal.

According to a second aspect of some embodiments of the present disclosure, there is provided a live interaction establishment method applicable to a host terminal, comprising: receiving target information, wherein the target information comprises request information indicating that a viewer terminal requests a live interaction with the host terminal; in response to receiving the target information, initiating a second connection of real time communication (RTC) to a second server.

According to a third aspect of the embodiments of the present disclosure, there is provided a live interaction establishment apparatus, comprising: a sending module, a receiving module, and an initiating module, wherein the sending module is used for sending request information to a first server, the request information indicates a request for a live interaction with a host terminal; the receiving module is used for receiving response information from the first server as feedback to the request information; the initiating module is used for, initiating a first connection of real time communication (RTC) to a second server based on the response information, before the receiving module receives allow information from the host terminal as feedback to the request information, wherein the allow information indicates that the host terminal agrees on live interaction with the viewer terminal.

According to a fourth aspect of the embodiments of the present disclosure, there is provided a live interaction establishment apparatus, comprising: a receiving module and an initiating module; the receiving module is used for receiving target information comprising: request information indicating that a viewer terminal requests live interaction with the host terminal; the initiating module is used for when the receiving module receives the target information, initiating a second connection of real time communication (RTC) to a second server.

According to a fifth aspect of the embodiments of the present disclosure, there is provided an electronic device comprising a processor, a memory, and a computer program stored on the memory and executable on the processor, wherein the computer program, when executed by the processor, implements the live interaction establishment method according to the first aspect.

According to a sixth aspect of the embodiments of the present disclosure, there is provided a computer-readable storage medium stored thereon a computer program that, when executed by a processor, implements the live interaction establishment method according to the first aspect.

According to a seventh aspect of the embodiments of the present disclosure, there is provided a computer program product comprising a computer program, the computer program product, when running on a processor, causes the processor to execute the computer program to implement the live interaction establishment method according to the first aspect.

According to an eighth aspect of the embodiments of the present disclosure, there is provided a chip comprising a processor and a communication interface coupled to the processor, the processor being used to execute program instructions to implement live interaction establishment method according to the first aspect.

According to a ninth aspect of the embodiments of the present disclosure, there is provided a computer program, comprising: instructions that, when executed by a processor, cause the processor to execute the live interaction establishment method described in the first aspect.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present disclosure or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a first flowchart of a live interaction establishment method provided in some embodiments of the present disclosure;

FIG. 2 is a second flowchart of the live interaction establishment method provided in some embodiments of the present disclosure;

FIG. 3 is a third flowchart of the live interaction establishment method provided in some embodiments of the present disclosure;

FIG. 4 is a first structural diagram of a live interaction establishment apparatus provided in some embodiments of the present disclosure;

FIG. 5 is a second structural diagram of the live interaction establishment apparatus provided in some embodiments of the present disclosure;

FIG. 6 is a schematic structural diagram of an electronic device provided in some embodiments of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

It should be noted that the terms “first”, “second” and the like in the description and claims of the present disclosure are used to distinguish similar objects, and are not necessarily used to describe a specific order or sequence. It should be understood that the terms so used may be interchanged where appropriate so that the embodiments of the disclosure described herein can be implemented in an order other than those illustrated or described herein. In addition, the objects distinguished by “first”, “second”, etc. are typically of the same type, without limitation as to the number of objects. For example, the first object may be one or more objects. In addition, in the description and claims, the word “and/or” represents at least one of the associated objects, and the character “/” generally indicates that the associated objects before and after “/” have an “or” relationship.

In related technologies, the process from sending request information from a viewer to receiving a first image frame of live interaction is usually time-consuming. Therefore, a live interaction failure may occur during the live interaction process due to an RTC connection timeout or the viewer aborting the live interaction.

In view of this, some embodiments of the present disclosure provide a live interaction establishment method for reducing the likelihood of live interaction failure.

The electronic device in some embodiments can be a viewer terminal or a host terminal, wherein the electronic device can be a mobile electronic device or a non-mobile electronic device. The mobile electronic device may be a mobile phone, a tablet, a laptop, a handheld computer, a vehicle-mounted electronic device, a wearable device, an Ultra Mobile Personal Computer (UMPC), a netbook, or a Personal Digital Assistants (PDA), etc; the non-mobile electronic device may be a Personal Computer (PC), a television (TV), an ATM, or a self-service machine, etc. some embodiments have no specific limitations thereto.

The execution entities of the live interaction establishment method provided in some embodiments of this disclosure are a viewer terminal and a host terminal. The viewer terminal and the host terminal can be electronic devices described above (comprising mobile electronic devices and non-mobile electronic devices), or functional modules and/or functional entities that can implement the live interaction establishment method in the electronic devices, which can be determined according to actual needs, and are not limited in some embodiments.

In some embodiments of the present disclosure, the viewer terminal and the host terminal are each a client, which comprises a livestreaming module (also known as a livestreaming service module) and a RTC module. The livestreaming module can communicate with a first server to complete the transmission of livestreaming service data with other clients (comprising the transmission of request information), etc. The RTC module can communicate with a second server to complete media stream exchange with other clients. Therefore, the transmission process of the request information and the RTC connection establishment process in the client do not affect each other, i.e. the two processes are independent and can be performed in parallel.

The first server forwards messages related to livestreaming services or livestreaming functions to the viewer terminal and the host terminal, which can also be referred to as a livestreaming service server, livestreaming server, livestreaming application (APP) server, etc.

The establishment of the connection of the RTC comprises stages such as initialization of the RTC (RTC init), channel join of the RTC, and streaming transmission of the RTC. For the specific processes, reference can be made to existing technologies, and are not limited here. The second server is a media server based on the Real-Time Message Transfer Protocol, which can forward media streams between different devices and achieve voice or video interaction between different devices. The second server is commonly referred to as a RTC server.

In some embodiments of the present disclosure, during the live interaction establishment stage, the livestreaming module on the viewer terminal communicates with the first server to complete the transmission of request information to the livestreaming module on the host terminal. The RTC module on the viewer terminal communicates with the second server to complete the media stream exchange with the RTC module on the host terminal to obtain a live interaction screen, and so on.

At present, in the stage of live interaction establishment, both the viewer terminal and the host terminal perform RTC connection establishment after completing the transmission of the request information. In some embodiments of the present disclosure, RTC connection establishment is initiated before completion of the transmission of the request information. Since the request information transmission process and the RTC connection establishment process can be performed independently of each other, performing these two processes simultaneously can shorten the duration of the live interaction establishment stage and reduce the probability of live interaction failure.

Below, with reference to the accompanying drawings, a detailed explanation of the live interaction establishment method provided in the present disclosure will be provided based on some specific embodiments and their application scenario.

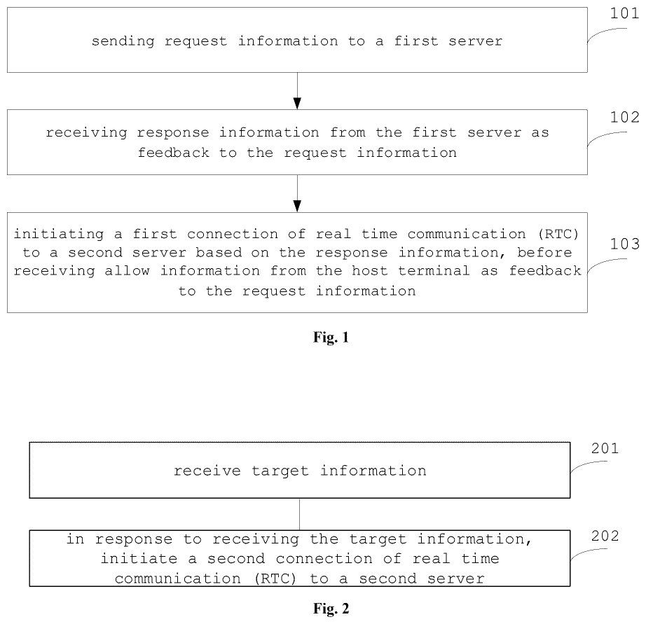

As shown in FIG. 1, some embodiments of the present disclosure provide a live interaction establishment method, which may comprise steps 101 to 103 as follows.

101: Send request information to a first server.

The request information is used to request live interaction with a host terminal.

102: Receive response information from the first server as feedback to the request information.

It can be understood that the viewer terminal receives a live interaction trigger operation, which is used to instruct live interaction with a host terminal. In response to the live interaction trigger operation, the viewer terminal sends request information to the first server; the first server receives the request information sent from the viewer terminal and sends response information to the viewer terminal based on the request information.

103: Before receiving allow information from the host terminal as feedback to the request information, initiate a first connection of real time communication (RTC) to a second server based on the response information.

The allow information indicates that the host terminal agrees on live interaction with the viewer terminal.

The initiation of the first connection of the RTC initiates a RTC establishment process and begins to establish a RTC connection.

It can be understood that after receiving the request information, the first server forwards the request information to the host terminal based on the request information, or updates a live interaction request list based on the request information, and then sends the updated live interaction request list (i.e., target information) to the host terminal.

The live interaction request list comprises the identification of at least one viewer terminal, each viewer terminal being a device that requests live interaction with the host terminal, and the at least one viewer terminal comprising the viewer terminal that sends the request information.

It can be understood that the host terminal receives request information (or a live interaction request list) sent from the first server. Then, based on the request information (or a live interaction request list), if the host terminal agrees on the live interaction request of the viewer terminal, it sends allow information to the viewer terminal via the first server; if the host terminal refuses the live interaction request of the viewer terminal, it sends live interaction reject information to the viewer terminal via the first server.

In some embodiments, the viewer terminal may initiate a first connection of real time communication (RTC) immediately upon receiving the response information, or the first connection of the RTC may be initiated within a period of time after receiving the response information but before receiving the allow information, which can be determined according to actual situations and is not limited here.

In some embodiments, the viewer terminal can initiate the first connection of the RTC at any time between the reception of the response information and the reception of the allow information, which can be determined according to actual situations and is not limited here.

In some embodiments of the present disclosure, request information can be sent to a first server, the request information indicates a request for live interaction with a host terminal; response information is received from the first server as feedback to the request information; before receiving allow information from the host terminal as feedback to the request information, a first connection of real time communication (RTC) between the host terminal and a second server is initiated based on the response information, wherein the allow information indicates that the host terminal agrees on live interaction with the viewer terminal. Since the transmission process of the response information and the RTC connection establishment process on the viewer terminal do not affect each other, these two processes can be performed simultaneously. Therefore, compared to initiating the first connection of the RTC after receiving allow information from the host terminal as feedback to the request information (i.e., after completion of the transmission process of the request information), the solution provided in some embodiments can shorten the time required for live interaction establishment by initiating the first connection of the RTC on the viewer terminal before receiving the allow information from the host terminal and after receiving the response information from the first server as feedback to the request information, thereby shortening the time required for live interaction establishment, i.e., the time between the viewer terminal sending the request information and obtaining a first image frame of live interaction, and thus reducing the probability of live interaction failure.

In some embodiments, (the establishment of) the first connection of the RTC comprises initialization of the RTC, channel join of the RTC, and streaming transmission of the RTC. The above step 203 can be specifically implemented as the following step 103a. The live interaction establishment method provided in some embodiments of the present disclosure may further comprise the following step 104.

103a: Perform a initialization of the RTC process before receiving the allow information.

104: After receiving the allow information, perform channel join of the RTC and streaming transmission of the RTC processes to establish the first connection of the RTC.

It can be understood that in some embodiments of the present disclosure, initialization of the RTC for the first connection of the RTC is performed after receiving the response information and before receiving the allow information. After receiving the allow information, channel join of the RTC and streaming transmission of the RTC are performed for the first connection of the RTC. Then, the live interaction establishment process is completed after completion of the streaming transmission of the RTC, achieving live interaction between the viewer terminal and the host terminal.

Initialization of the RTC establishes a basic connection between the RTC module on the viewer terminal and the second server, which occupies less resources of the second server; channel join of the RTC requires a virtual channel to be created on the second server side, and then the viewer terminal joins the virtual channel and performs some subscription-related processing, which may occupy a lot of resources on the second server during this process. Therefore, in some embodiments, only the initialization of the RTC of the first connection of the RTC is performed before receiving the allow information, which does not occupy too many resources of the second server and can shorten the time required for the live interaction process and reduce the probability of live interaction failure.

In some embodiments, there is no restriction on the order of an establishment of the first connection of the RTC process and the transmission of the allow information, that is, the establishment of the first connection of the RTC process and the transmission process of the allow information are performed completely in parallel. Therefore, the allow information can be received during the establishment of the first connection of the RTC process or after the first connection of the RTC is established.

In some embodiments, after step 103, the live interaction establishment method provided in some embodiments of the present disclosure may further comprise the following step 105.

105: During the establishment of the first connection of the RTC, receive the allow information.

In some embodiments of the present disclosure, the first connection of the RTC is initiated before receiving the allow information, without limiting the order of establishing the first connection of the RTC and receiving the allow information. That is, the parallel execution of the establishment of the first connection of the RTC and the transmission of the request information can effectively shorten the time live interaction establishment and reduce the probability of live interaction failure.

In other embodiments, after step 103, the live interaction establishment method provided in some embodiments of the present disclosure may further comprise the following step 106.

106: Release the first connection of the RTC if the allow information is not received within a preset time after the first connection of the RTC is established.

The preset time can be determined based on actual situations, and is not limited here.

If no allow information is received within the preset period of time after the first connection of the RTC is established, it indicates that the live interaction request initiated by the viewer terminal is not successful. Therefore, the first connection of the RTC is released to release the resources occupied by the first connection of the RTC established between the RTC module on the viewer terminal and the second server, thereby improving resource utilization.

In some embodiments, after step 103, the live interaction establishment method provided in some embodiments of the present disclosure may further comprise the following step 107.

107: After the first connection of the RTC is established, receive the allow information sent from the host terminal via the first connection of the RTC.

It can be understood that the delay in message transmission through the first server is higher than that through the second server. Therefore, after the first connection of the RTC is established, the allow information sent from the host terminal via the first connection of the RTC is received. This can shorten the time required to receive the allow information, thereby reducing the probability of live interaction failure.

In some embodiments, based on the above step 107, in some embodiments of the present disclosure, the viewer terminal can also receive the allow information sent from the host terminal through the first server. That is, before or after the above step 107, the viewer terminal can receive the allow information sent from the host terminal through the first server. In this way, the way for the viewer terminal to receive the allow information is expanded. No matter which way the allow information is received first, it indicates successful live interaction (the live interaction is successfully established). Therefore, it can shorten the time consumption of the live interaction process to some extent and reduce the probability of live interaction failure.

As shown in FIG. 2, some embodiments of the present disclosure provide a live interaction establishment method, which may comprise steps 201 to 202 as follows.

201: Receive target information.

The target information comprises request information indicating that a viewer terminal requests a live interaction with the host terminal.

202: If the target information is received (e.g., when the target information is received), initiate a second connection of real time communication (RTC) to a second server.

In some embodiments, when a request list is received, a second connection of real time communication (RTC) to a second server is initiated.

In some embodiments, in combination with the relevant descriptions of steps 101 to 105 in the above method embodiment, the target information can be the request information or the live interaction request list described above. In some embodiments, a second connection of real time communication (RTC) to the second server is initiated upon the target information is received. Since for the host terminal, the transmission of the request information and the RTC connection establishment do not affect each other, these two processes can be performed simultaneously. When the host terminal receives the target information, the second connection of the RTC is initiated. Therefore, compared to initiating the RTC connection after the allow information is fed back to the viewer terminal (i.e., the transmission of the request information is completed), the solution provided in some embodiments can shorten the time consumed by the live interaction establishment process by initiating the RTC connection when the target information is received on the requested host terminal. Thus, the time required for live interaction establishment, i.e., the time between the viewer terminal sending the request information and acquiring a first image frame of live interaction, can be shortened, thereby reducing the probability of live interaction failure and improving live interaction efficiency.

In some embodiments, after step 202, the live interaction establishment method provided in some embodiments of the present disclosure may further comprise the following step 203.

203: After completion of the establishment of the second connection of the RTC, send allow information through the second connection of the RTC, wherein the allow information indicates an agreement on live interaction with the viewer terminal.

In some embodiments, sending allow information through the second connection of the RTC comprises: (the host terminal) sending the allow information to the second server through the second connection of the RTC, wherein the second server sends the allow information to the viewer terminal through the first connection of the RTC.

In other embodiments, the live interaction establishment method further comprises: sending the allow information to the viewer terminal through a first server, the allow information indicates an agreement on live interaction with the viewer terminal.

Based on the above step 203, in some embodiments of the present disclosure, the host terminal can also send allow information to the viewer terminal through the first server. That is, before or after the above step 203, the host terminal can send allow information sent to the viewer terminal through the first server. In this way, the way for the viewer terminal to receive the allow information is expanded. No matter which way the allow information is received first, it indicates successful live interaction. Therefore, it can shorten the time consumption of the live interaction process to some extent and reduce the probability of live interaction failure.

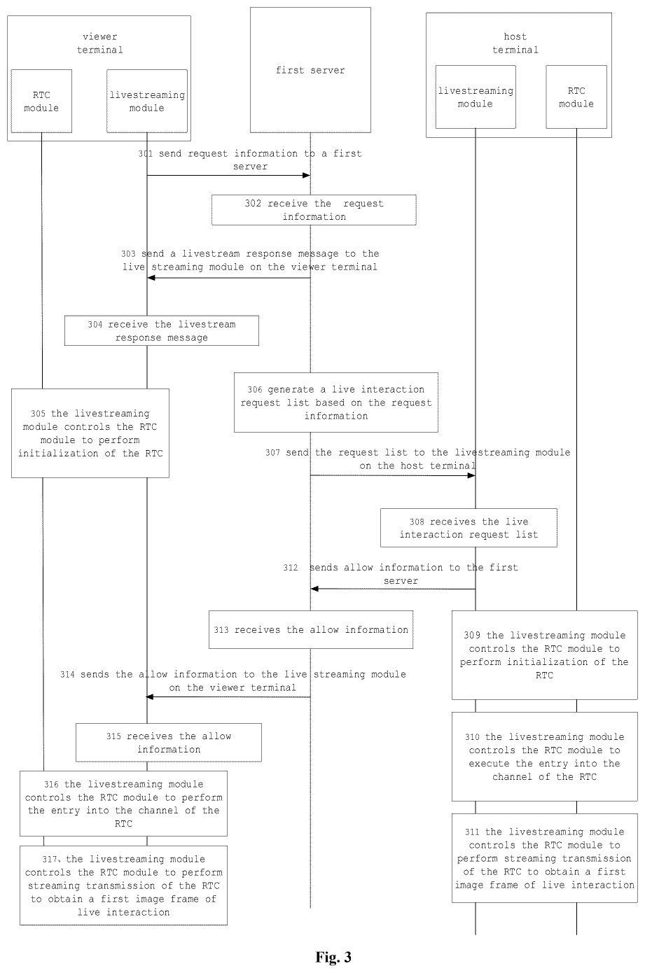

As an illustration, as shown in FIG. 3, the live interaction establishment method provided in some embodiments of the present disclosure may comprise the following steps 301 to 317.

301: the livestreaming module on a viewer terminal sends request information to a first server.

302: the first server receives the request information.

There is no limit to the order in which steps 303 to 305 and steps 306 to 307 may be performed.

303: The first server sends a response information to the live streaming module on the viewer terminal.

304: The livestreaming module on the viewer terminal receives the response information.

305: The livestreaming module on the viewer terminal controls the RTC module on the viewer terminal to perform initialization of the RTC.

306: The first server generates a live interaction request list based on the request information.

307: The first server sends the live interaction request list to the livestreaming module on the host terminal.

308: The livestreaming module on the host terminal receives the live interaction request list.

The livestreaming module on the host terminal agrees on live interaction with the viewer terminal based on the live interaction request list.

309: The livestreaming module on the host terminal controls the RTC module on the host terminal to perform initialization of the RTC.

310: The livestreaming module on the host terminal controls the RTC module on the host terminal to perform the channel join of the RTC.

311: The livestreaming module on the host terminal controls the RTC module on the host terminal to execute streaming transmission of the RTC to obtain a first image frame of live interaction.

312: The livestreaming module on the host terminal sends allow information to the first server.

313: The first server receives the allow information.

314: The first server sends the allow information to the live streaming module on the viewer terminal.

315: The livestreaming module on the viewer terminal receives the allow information.

316: The livestreaming module on the viewer terminal controls the RTC module on the viewer terminal to perform the channel join of the RTC.

317: The livestreaming module on the viewer terminal controls the RTC module on the viewer terminal to perform streaming transmission of the RTC to obtain a first image frame of live interaction.

The establishment of a live interaction connection between the viewer terminal and the host terminal is completed, and the viewer terminal and the host terminal can interact through the live interaction connection.

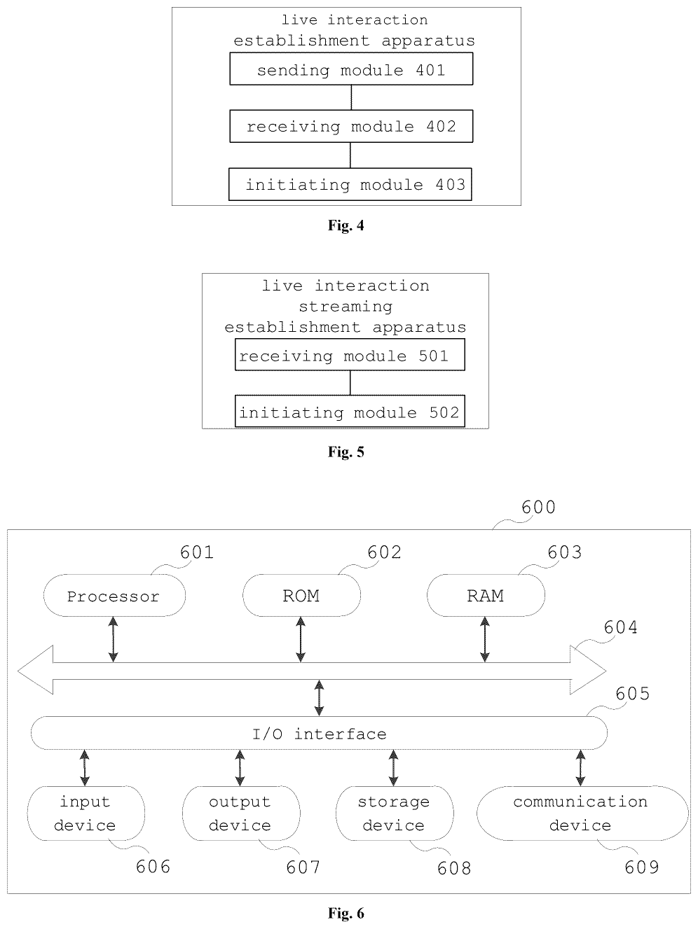

FIG. 4 is a structural block diagram of a live interaction establishment apparatus provided by some embodiments of the present disclosure. As shown in FIG. 4, the live interaction establishment apparatus comprises: a sending module 401, a receiving module 402, and an initiating module 403. The sending module 401 is used for sending request information to a first server, the request information indicates a request for a live interaction with a host terminal. The receiving module 402 is used for receiving response information from the first server as feedback to the request information. The initiating module 403 is used for, before the receiving module 402 receives allow information from the host terminal as feedback to the request information, initiating a first connection of real time communication (RTC) to a second server based on the response information, the allow information indicates that the host terminal agrees on live interaction with the viewer terminal.

In some embodiments, the apparatus further comprises: an execution module. The (establishment of) first RTC connection comprises initialization of the RTC, channel join of the RTC, and streaming transmission of the RTC. The initiating module 403 is particularly used for performing a initialization of the RTC process before receiving the allow information. The execution module is used for perform channel join of the RTC and streaming transmission of the RTC processes to establish the first connection of the RTC after the allow information is received.

In some embodiments, the receiving module 402 is further used for, before allow information is received from the host terminal as feedback to the request information, and after a first connection of real time communication (RTC) to a second server is initiated based on the response information, receiving the allow information during the establishment of the first connection of the RTC.

In some embodiments, the apparatus further comprises: a release module. The release module is used for, before allow information is received from the host terminal as feedback to the request information and after initiating the first connection of RTC to a second server based on the response information, releasing the first connection of the RTC if the allow information is not received within a preset period of time after the first connection of the RTC is established.

In some embodiments, the receiving module 402 is also used for, after initiating the first connection of RTC, receiving the allow information sent from the host terminal through the first connection of the RTC in the case where the first RTC has been established.

In other embodiments, the receiving module 402 is further used for receiving the allow information sent from the host terminal through the first server.

The various modules in some embodiments can implement the live interaction establishment method provided in the above method embodiment, and can achieve the same technical effect, which will not be repeated here to avoid repetition.

FIG. 5 is a structural block diagram of a live interaction establishment apparatus provided by some embodiments of the present disclosure. As shown in FIG. 5, the live interaction establishment apparatus comprises: a receiving module 501 and an initiating module 502. The receiving module 501 is used for receiving target information comprising: request information indicating that a viewer terminal requests a live interaction with the host terminal. The initiating module 502 is used for, if the receiving module 501 receives the target information, initiating a second connection of real time communication (RTC) to a second server.

In some embodiments, the apparatus further comprises: a sending module. After the establishment of the second connection of the RTC to the second server is initiated, when the target information is received, the sending module is used for sending allow information through the second connection of the RTC in the case where the second connection of the RTC has been established, the allow information indicates an agreement on live interaction with the viewer terminal.

In some embodiments, the sending module is used for sending the allow information to the second server through the second connection of the RTC, wherein the second server sends the allow information to the viewer terminal through the first connection of the RTC.

In some embodiments, the apparatus further comprises: a sending module. The sending module sends the allow information to the viewer terminal through the first server, the allow information indicates an agreement on live interaction with the viewer terminal.

The various modules in some embodiments can implement the live interaction establishment method provided in the above method embodiment, and can achieve the same technical effect, which will not be repeated here to avoid repetition.

According to some embodiments of the present disclosure, there is provided a computer program, comprising: instructions that, when executed by a processor, cause the processor to perform the live interaction establishment method described above.

FIG. 6 is a schematic structure diagram of an electronic device provided by some embodiments of the present disclosure, for illustrating the electronic device implementing the live interaction establishment method provided by any embodiment of the present disclosure, and should not be understood as a specific limitation of the embodiments of the present disclosure.

As shown in FIG. 6, the electronic device 600 may comprise a processor (e.g., a central processing unit, a graphics processor) 601, which may perform various appropriate actions and processes according to a program stored in Read Only Memory (ROM) 602 or a program loaded from storage device 608 into Random Access Memory (RAM) 603. In RAM 603, various programs and data required for the operation of the electronic device 600 are also stored. The processor 601, ROM 602, and RAM 603 are connected to each other through a bus 604. An input/output (I/O) interface 605 is also connected to the bus 604.

Generally, the following devices can be connected to I/O interface 605: input devices 606 comprising, for example, a touch screen, a touch pad, a keyboard, a mouse, a camera, a microphone, an accelerometer, a gyroscope, etc; output devices 607 comprising a liquid crystal display (LCD), a speaker, a vibrator, etc.; a storage device 608 such as a magnetic tape, a hard disk, etc; and a communication device 609. The communication device 609 enables the electronic device 600 to communicate in a wireless or wired manner with other devices to exchange data. Although FIG. 6 shows the electronic device 600 with various components, it should be understood that it is not required to implement or have all of these components. Alternatively, more or fewer components can be implemented or provided.

In particular, according to some embodiments of the present disclosure, the processes described above with reference to the flowchart can be implemented as a computer software program. For example, some embodiments of the present disclosure comprise a computer program product, which comprises a computer program carried on a non-transitory computer readable medium, and containing program code for executing the method shown in the flowchart. In such an embodiment, the computer program may be downloaded and installed from the network through the communication device 609, or installed from the storage device 608, or from the ROM 602. When the computer program is executed by the processor 601, the above functions defined in the live interaction establishment method provided by any embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks comprise a local area network (“LAN”) and a wide area network (“WAN”), the Internet, and end-to-end networks (for example, ad hoc end-to-end networks), as well as any currently known or future developed networks.

The above computer readable medium may be comprised in the electronic device described above; or it may exist alone without being assembled into the electronic device.

The computer readable medium described above carries one or more programs that, when executed by the electronic device, cause the electronic device (which comprises a viewer terminal) to perform steps of: sending request information to a first server, the request information indicates a request for a live interaction with a host terminal; receiving response information from the first server as feedback to the request information; before receiving allow information from the host terminal as feedback to the request information, initiating a first connection of real time communication (RTC) to a second server based on the response information, the allow information indicates that the host terminal agrees on live interaction with the viewer terminal.

Alternatively, the above computer-readable medium carries one or more programs that, when executed by the electronic device, cause the electronic device (which comprises a host terminal) to perform steps of: receiving target information, the target information comprising: request information indicating that a viewer terminal requests a live interaction with the host terminal; in response to receiving the target information, initiating a second connection of real time communication (RTC) to a second server.

In the present disclosure, computer program code for executing operations of the present disclosure may be complied by any combination of one or more program design languages, the program design languages comprising, but not limited to, object-oriented program design languages, such as Java, Smalltalk, C++, etc, as well as conventional procedural program design languages, such as “C” program design language or similar program design language. The program code may be completely or partly executed on a computer, or executed as an independent software package, partly executed on the computer and partly executed on a remote computer, or completely executed on a remote computer or server. In the latter circumstance, the remote computer may be connected to a computer through various kinds of networks, comprising local area network (LAN) or wide area network (WAN), or connected to an external computer (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. The names of the units do not constitute a limitation on the units themselves under certain circumstances.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a computer-readable medium may be a tangible medium, which may contain or store a program for use by or in connection with an instruction execution system, apparatus, or device. The computer readable medium can be a computer readable signal medium or a computer readable storage medium. The computer readable medium may comprise, but is not limited to, an electronic, magnetic, optical, electromagnetic, infrared, or semiconductor system, apparatus, or device, or any suitable combination of thereof.

More specific examples of the computer readable storage medium may comprise electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

The above description is only preferred embodiments of the present disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. A live interaction establishment method applicable to a viewer terminal, comprising:
sending request information to a first server, wherein the request information indicates a request for live interaction with a host terminal;
receiving response information from the first server as feedback to the request information; and
initiating a first connection of real time communication (RTC) to a second server based on the response information, before receiving allow information from the host terminal as feedback to the request information, wherein the allow information indicates that the host terminal agrees on live interaction with the viewer terminal.

2. The live interaction establishment method according to claim 1, wherein the first connection of the RTC comprises initialization of the RTC, channel join of the RTC, and streaming transmission of the RTC,
the initiating the first connection of the RTC to the second server based on the response information before receiving the allow information from the host terminal as the feedback to the request information comprises:
performing the initialization of the RTC before receiving the allow information; and
the method further comprises:
performing the channel join of the RTC and streaming transmission of the RTC to establish the first connection of the RTC, after receiving the allow information.

3. The live interaction establishment method according to claim 1, further comprising, after the initiating the first connection of the RTC to the second server based on the response information before receiving the allow information from the host terminal as the feedback to the request information:
receiving the allow information during an establishment of the first connection of the RTC; or
releasing the first connection of the RTC in response to not receiving the allow information within a preset time period after completion of the establishment of the first connection of the RTC.

4. The live interaction establishment method according to claim 1, further comprising:
receiving the allow information sent from the host terminal through the first connection of the RTC in response to completion of an establishment of the first connection of the RTC, after initiating the first connection of the RTC to the second server.

5. The live interaction establishment method according to claim 1, further comprising:
receiving the allow information sent from the host terminal through the first server.

6. A live interaction establishment method applicable to a host terminal, comprising:
receiving target information, wherein the target information comprises request information indicating that a viewer terminal requests live interaction with the host terminal; and
initiating a second connection of the real time communication (RTC) to a second server, in response to receiving the target information.

7. The live interaction establishment method according to claim 6, further comprising:
sending allow information through the second connection of the RTC, after completion of an establishment of the second connection of the RTC, wherein the allow information indicates an agreement on the live interaction with the viewer terminal.

8. The live interaction establishment method according to claim 7, wherein the sending the allow information through the second connection of the RTC comprises:
sending the allow information to the second server through the second connection of the RTC, wherein the second server sends the allow information to the viewer terminal through a first connection of the RTC.

9. The live interaction establishment method according to claim 6, further comprising:
sending allow information to the viewer terminal through a first server, wherein the allow information indicates an agreement on the live interaction with the viewer terminal.

10-11. (canceled)

12. An electronic device, comprising: a memory for storing computer programs; a processor for performing, by invoking the computer programs, the live interaction establishment method according to claim 1.

13. A non-transitory computer-readable storage medium stored thereon a computer program that, when executed by a processor, implements the live interaction establishment method according to claim 1.

14-15. (canceled)

16. An electronic device, comprising: a memory for storing computer programs; a processor for performing, by invoking the computer programs, the live interaction establishment method according to claim 2.

17. An electronic device, comprising: a memory for storing computer programs; a processor for performing, by invoking the computer programs, the live interaction establishment method according to claim 3.

18. An electronic device, comprising: a memory for storing computer programs; a processor for performing, by invoking the computer programs, the live interaction establishment method according to claim 4.

19. An electronic device, comprising: a memory for storing computer programs; a processor for performing, by invoking the computer programs, the live interaction establishment method according to claim 5.

20. A non-transitory computer-readable storage medium stored thereon a computer program that, when executed by a processor, implements the live interaction establishment method according to claim 2.

21. A non-transitory computer-readable storage medium stored thereon a computer program that, when executed by a processor, implements the live interaction establishment method according to claim 3.

22. A non-transitory computer-readable storage medium stored thereon a computer program that, when executed by a processor, implements the live interaction establishment method according to claim 4.

23. A non-transitory computer-readable storage medium stored thereon a computer program that, when executed by a processor, implements the live interaction establishment method according to claim 5.

24. A non-transitory computer-readable storage medium stored thereon a computer program that, when executed by a processor, implements the live interaction establishment method according to claim 6.
